(19) United States
(12) Patent Application Publication
(10) Pub. No.: US 2016/0019667 A1
(43) Pub. Date: Jan. 21, 2016

(54) APPARATUS AND METHOD FOR PERFORMING SOCIAL WORK

(71) Applicant: Meshal Sager Mohammed ALOTAIBI, Arlington, TX (US)

(72) Inventor: Meshal Sager Mohammed ALOTAIBI, Arlington, TX (US)

(21) Appl. No.: 14/331,680

(22) Filed: Jul. 15, 2014

(51) Int. Cl. G06Q 50/26; G06F 17/30

(52) U.S. Cl. CPC G06Q 50/26; G06F 17/30324; G06F 17/30595

(57) ABSTRACT

A social work plan development apparatus stores client needs profiles as vectors P in a database, receives a query that includes client attribute data that is based on a primary issue and/or need of a client, and characterizes the client attribute data as an A vector. The A vector is then correlated with the P vectors stored in the database to determine the magnitude of correlation between the A vector and the P vectors with respect to the query through a vector overlap process. The magnitude of correlation between the A vector and the P vectors is used to determine the root cause of the issue and/or need that the client is facing. Goals and/or treatments addressing the root cause of the issue and/or need are determined, and client progress toward accomplishing the goals and/or treatments within a predetermined time is evaluated.

### GRANT OF NON-EXCLUSIVE RIGHT

This application was prepared with financial support from the Saudia Arabian Cultural Mission, and in consideration therefore the present inventor has granted, the Kingdom of Saudi Arabia a non-exclusive right to practice the present invention.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the practice of social work, the issues that clients face can be complex and can cover a wide range of subjects. There are also many different models for diagnosing, treating, and evaluating clients that can make it difficult for a social worker to determine the proper path to follow while treating a client.

### SUMMARY

A social work plan development apparatus can store client needs profiles as vectors P in a database, receives a query that can include client attribute data based on a primary issue and/or need of a client, and characterizes the client attribute data as an A vector. The social work plan development apparatus correlates the A vector with the P vectors to determine magnitude of correlation between the A vector and the P vectors with respect to the query through a vector overlap process and determines a root cause for the issue and/or need of the client based on the magnitude of correlation between the A vector and the P vectors. At least one goal and/or treatment is determined for the client that addresses the root cause for the issue and/or need of the client, and client progress is evaluated within a predetermined timeframe based on a percentage of accomplishment of the at least one goal and/or treatment.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a graphical illustration of a user interface for a social work plan development apparatus according to certain embodiments.

FIG. 1B is an exemplary schematic diagram of a system for developing a social work plan according to certain embodiments.

FIG. 2 is an exemplary flowchart of a social work plan development process according to certain embodiments.

FIG. 3 is an exemplary flowchart of the client attribute comparison process according to certain embodiments.

FIG. 4 is a data structure of the client attribute data that is used to characterize a particular client according to certain embodiments.

FIG. 5 is a data structure of a client profile vector that includes attributes regarding potential client profiles that are stored in the database according to certain embodiments.

FIG. 6 is a graph of a client attribute vector and a client profile vector in two dimensional space according to certain embodiments.

FIG. 7 is a graphical illustration of how pairs of vectors (P, C) are compared to one another to arrive at a determination of an amount of commonality between the two vectors according to certain embodiments.

FIG. 8 is a flowchart of a vector overlap process for determining the overlap amounts for the client attribute vector and the different component client profile vectors according to certain embodiments.

FIG. 9 is an exemplary flowchart of a client treatment and goal setting process according to certain embodiments.

FIG. 10 is an exemplary flowchart of a client evaluation process according to certain embodiments.

FIG. 11 illustrates a non-limiting example of client goal and/or treatment information for an infant foster child who is adopted according to certain embodiments.

FIG. 12 is a block diagram of circuitry that implements any of the processors or computer-resources described herein when programmed to perform the algorithms described herein.

### DETAILED DESCRIPTION

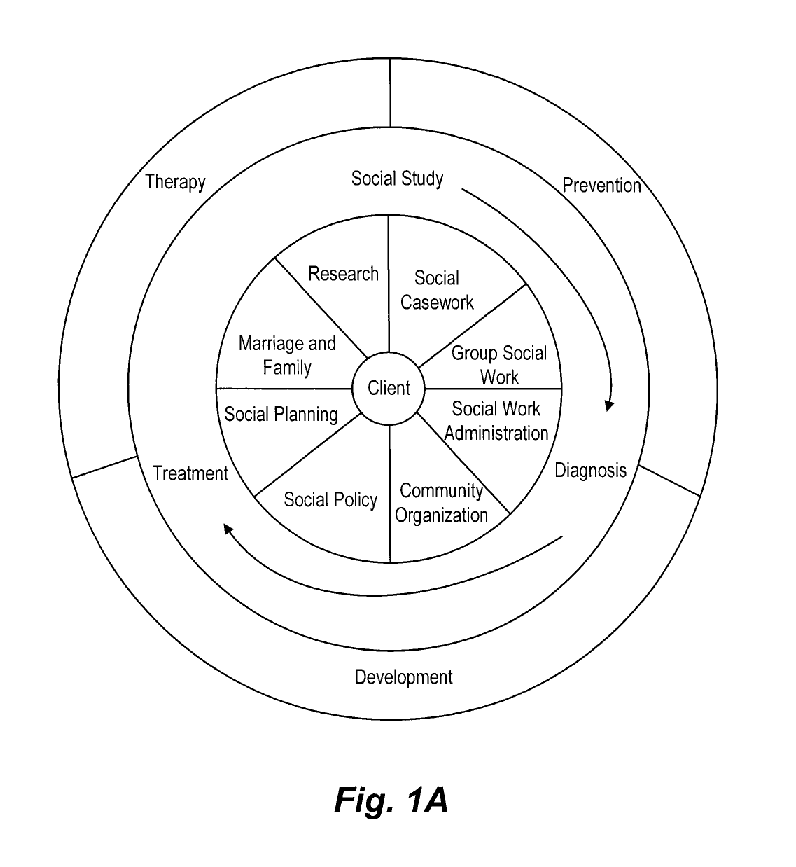

Referring now to the drawings, wherein like reference numerals designate identical or corresponding parts throughout the several views, the following description relates to a device and associated methodology for developing a framework to assist social workers in diagnosing, treating, and evaluating clients which can include individuals, families, groups, or communities. FIG. 1A is a graphical illustration of a user interface for a social work plan development apparatus according to certain embodiments. The user interface demonstrates a client-centric approach to social work that includes a plurality of methods, processes, and goals. Specifically, the user interface is a part of a social work plan development apparatus, which is a tool that assists a social worker in caring for clients using methods that can include casework, group social work, community organization, social policy, social planning, marriage and family social work, social work research, and social work administration.

Social casework can include assisting individuals or families solve interpersonal, socioeconomic, and environmental problems through face-to-face interaction and relationships. Group social work can include leading controlled, therapeutic discussions to exchange information, develop social and manual skills, change value orientations, and divert antisocial behaviors into productive channels. Community organization can include intervening to assist individuals, groups, and communities with common interests or from one geographic area to deal with common social problems to enhance the social well-being of the community. Social policy can include developing policies within a society to enhance the society's education, healthcare, and economic systems. Social planning can include developing systematic procedures to achieve predetermined socioeconomic structures in order to manage changes in social structures. Marriage and family social work can include intervening in a marital or familial relationship to clarify roles within the relationship and enhance verbal and nonverbal communication skills. Social work research can include conducting a systematic investigation to test hypotheses pertaining to social issues and human relationships. Social work administration can include managing the goals of a social agency, evaluating the success of social programs, and improving efficiency of the organization in order to better serve clients.

Once the method of social work is determined, the user interface of the social work plan development apparatus includes processes through which the social worker interacts with the client. The social worker conducts a social study of the client to collect and organize information relevant to serving the client's needs. In some embodiments, the information relevant to serving the client's needs may be referred to as client attribute data. Details pertaining to the social study process which results in the collection and organization of the client attribute data are discussed further herein.

Another process through which the social worker interacts with the client is through a diagnosis process which can include analyzing the client information obtained during the social study process to determine the root cause of the client's primary issue and/or need. In some embodiments, the diagnosis process can be executed as a client attribute comparison process where the client attribute data obtained in the social study phase is compared to stored client profiles in a database through a vector overlap process that outputs at least one potential root cause of the primary issue and/or need of the client. Details pertaining to the diagnosis process are discussed further herein.

Another process through which the social worker interacts with the client is through a treatment process. The treatment process can include establishing a treatment plan, identifying therapeutic targets or models, and implementing the treatment plan or intervention. In some embodiments, the treatment of the primary issue/and or need of the client can be performed in conjunction with a goal setting process. Details pertaining to the treatment process are discussed further herein.

Next, the user interface of the social work plan development apparatus includes types of goals that the social worker can implement to help the client clarify and define the objectives they hope to achieve and then the next steps that can be taken in addition to assigning timelines for accomplishment of the goals. A category of goals can include prevention goals in which the social worker identifies actions that can be taken to minimize or eliminate social, psychological, or other conditions known to cause or contribute to social problems. Next, another category of goals can include development goals in which the social worker evaluates physical, mental, social, and environmental changes in the client over time and tailors the goals to fit with how the client develops. Another category of goals can include therapy goals in which the social worker identifies methods or activities designed for clients to remedy a problem or disease. In some embodiments, the goal setting can be executed by accessing a database of stored goal information that is tied to an identified root cause of the client's primary issue and/or need. Details of client goal setting are discussed further herein.

According to certain embodiments, the social worker receives client data pertaining to the client's basic information, social needs, deficiencies, and/or risk factors. Through a social work plan development process, this social work plan development apparatus assists the social worker with diagnosing the client, developing measurable and achievable goals and treatments for the client, treating the client, and evaluating the client's progress. The social work plan development process includes, in selected embodiments, matching the client attribute data to a database of stored attributes to determine one or more problems and/or risk factors, developing goals and/or treatments for the client, and evaluating the client's progress toward reaching the goals or completing the treatments. In one implementation, these phases are executed sequentially and receive the output from the previous phase as well as user input in order to carry out their processes. In other aspects, these phases may be executed concurrently or in a different order so that adjustments to the scope of the social work plan development process or changes in the phases of implementation of the social work plan development process can be made in real time.

Next, FIG. 1B is an exemplary schematic diagram of a system for developing a social work plan according to certain embodiments. A computer 2 is connected to a server 4, a database 6 and a mobile device 8 via a network 10. The server 4 represents one or more servers connected to the computer 2, the database 6 and the mobile device 8 via the network 10. The computer 2 may interchangeably be known as the social work plan development apparatus as described further herein. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8.

The computer 2 includes an interface, such as a keyboard and/or mouse, allowing a user, such as a social worker, to input client attribute data pertaining to the client's social needs, deficiencies, and/or risk factors which is then transmitted to the server 4 via network 10. In selected embodiments, the client may be a child whose parents are going through a divorce. The client attribute data for this case may include symptoms such as poor school performance, poor concentration, increased irritability, inability to enjoy favorite foods, changes in eating and sleeping patterns, and the like. However, the client attribute data can also relate to any category of social work depending on the type of client, which may include adults, elderly people, couples, families, groups, communities, and the like. The client attribute data that is input by the social worker to the interface at the computer 2 can be input by selecting one or more attributes from a list of possible client attributes, manually entering the client attributes, or the like.

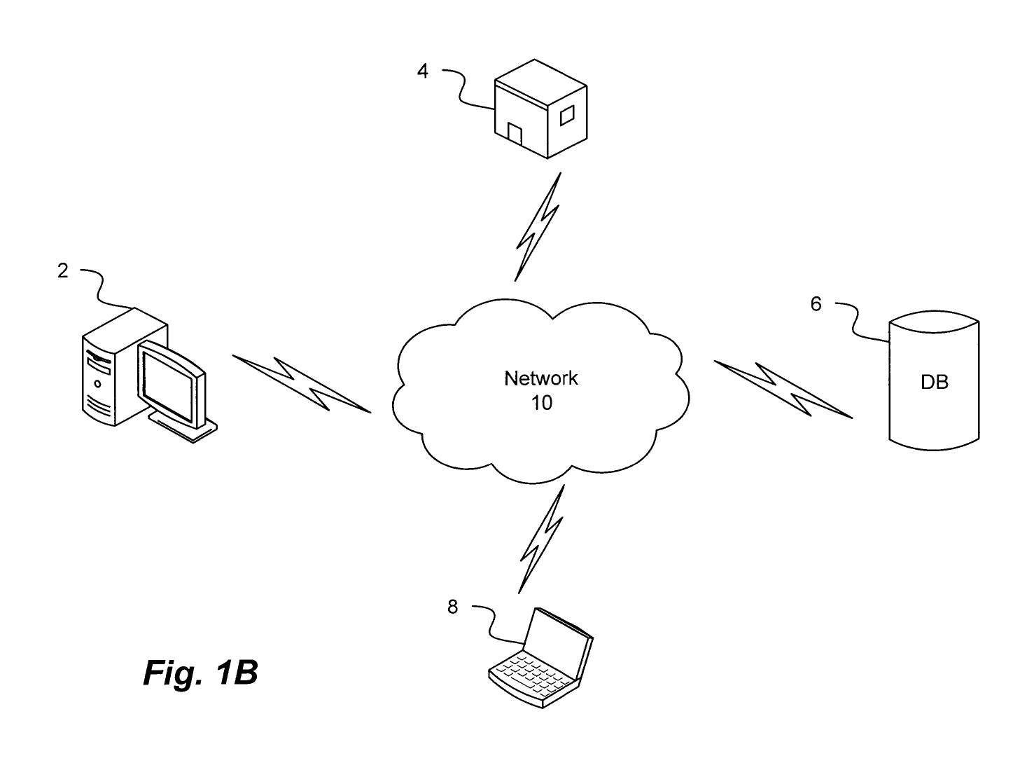

Once the client attribute data is received by the server 4, the server 4 uses the client attribute data to query the database 6 via network 10 to complete a social work plan development process. The database 6 is composed of categorical sets of data pertaining to a wide variety of social work issues, which may include basic client information, symptoms, risk factors, goals, treatments, and evaluation methods for individuals, families, groups, and communities. The social work plan development process can include, in selected embodiments, matching the client attribute data to the database 6 of stored client needs profiles to determine one or more problems and/or risk factors, develop goals and/or treatments for the client, and evaluate the client's progress toward reaching the goals. The details of the social work plan development process are discussed further with regard to FIG. 2. The client attribute data is also saved in memory of the server 4 and/or computer 2/mobile device 8 and can be displayed on the display screen of computer 2 and can also be sent to a variety of external devices, such as a mobile device 8, via text, email, or any other related method.

Based on the teachings herein, the mobile device 8 or any other external device could also be used in the same manner as the computer 2 to receive the client attribute data from an interface and send the client attribute data to server 4 and database 6 via network 10 to complete the social work plan development process. In one implementation, a user, such as a social worker, uses an application on his or her Smart Phone to input client attributes after a counseling session at a school or hospital.

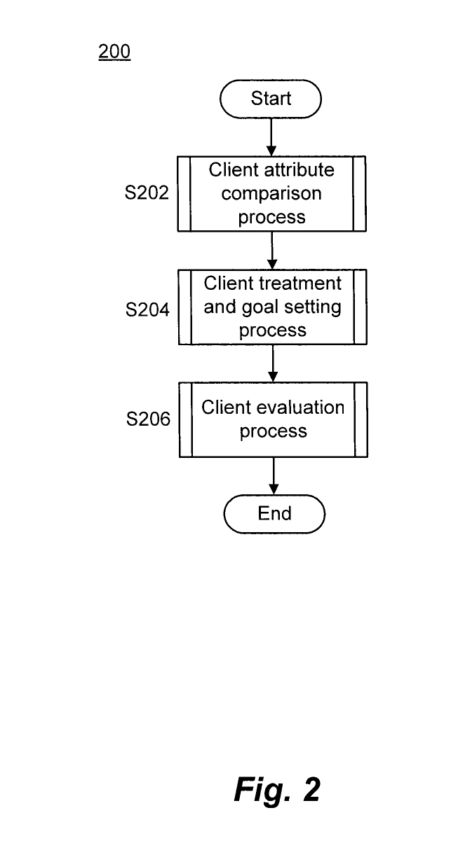

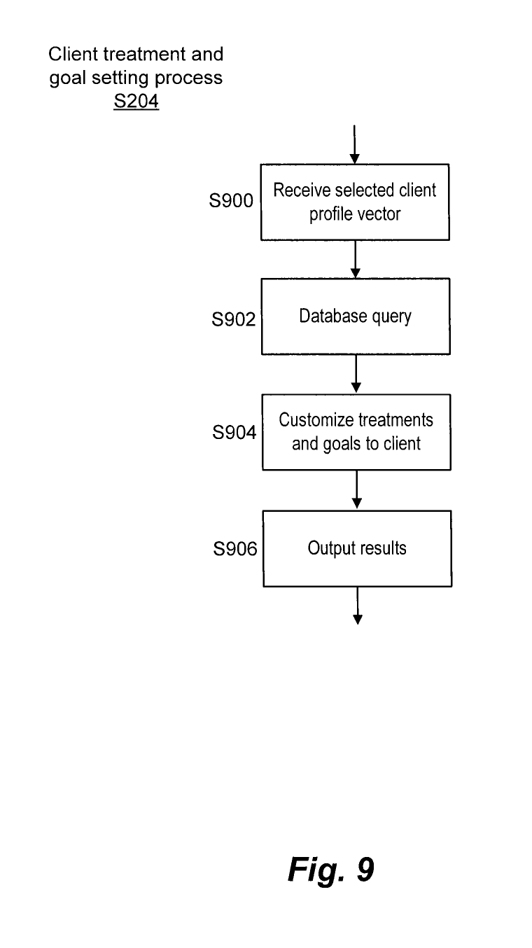

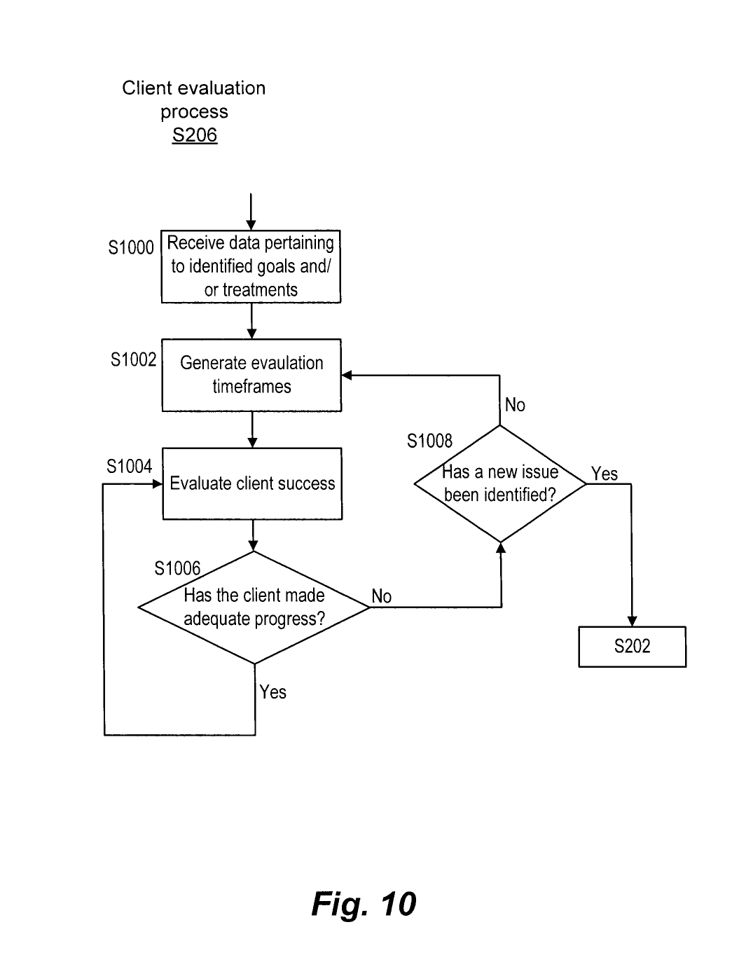

Next, FIG. 2 is an exemplary flowchart of a social work plan development process 200 according to certain embodiments. At step S202, a client attribute comparison process is executed which can encompass the social study and diagnosis processes of social work. The client attribute comparison process is discussed further with respect to FIG. 3. At step S204, a client treatment and goal setting process is executed. The client treatment and goal setting process is discussed further with respect to FIG. 9. At step S206, a client evaluation process is executed. The evaluation process is discussed further with respect to FIG. 10.

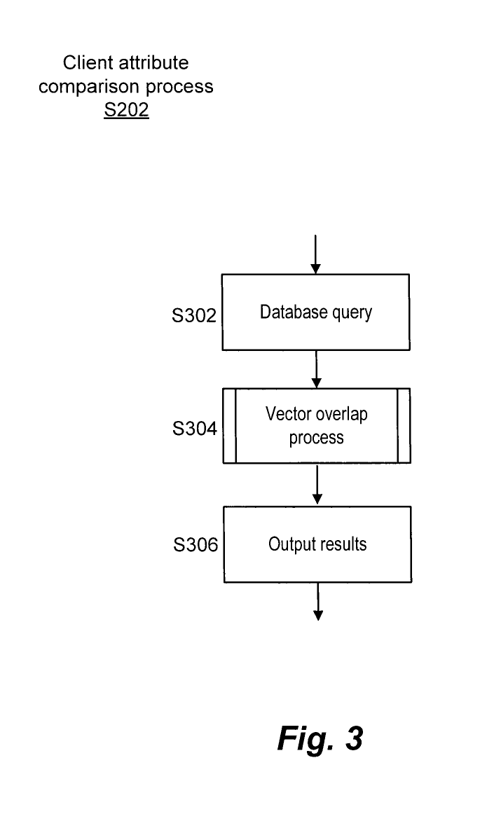

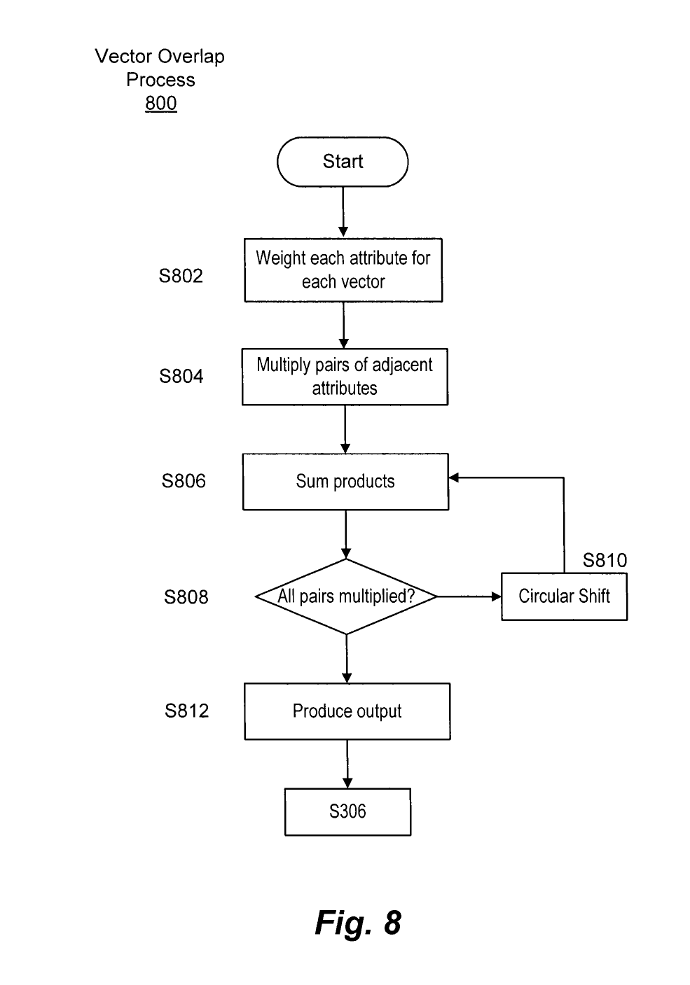

Next, FIG. 3 is an exemplary flowchart of the client attribute comparison process according to certain embodiments. At step S302, a query of the database 6 of the stored client needs profiles is conducted. The query can consist of the social worker inputting client attribute data into the interface at the computer 2. In some embodiments, the inputting of client data can also be referred to as the client social study process. The client attribute data can consist of information such as the number of clients (e.g., in a family, group, community, etc.), average age, client gender, a primary issue and/or need, and the like. The client attribute data is then formed into a client attribute vector as discussed with respect to FIG. 4. The process then proceeds to step S304 where a vector overlap process is applied to the client attribute vector. The vector overlap process of step S304 will be discussed further with respect to FIG. 8. The output of the vector overlap process of step S304 is produced at step S306. The output may be a graphical representation of the correspondence between the client attribute data and client profiles that are stored in the database 6, a percentage of correspondence between the client attribute data and the client profiles that are stored in the database, a top number of corresponding client profiles, or the like. According to certain embodiments, the output at step S306 can be treated as a client diagnosis.

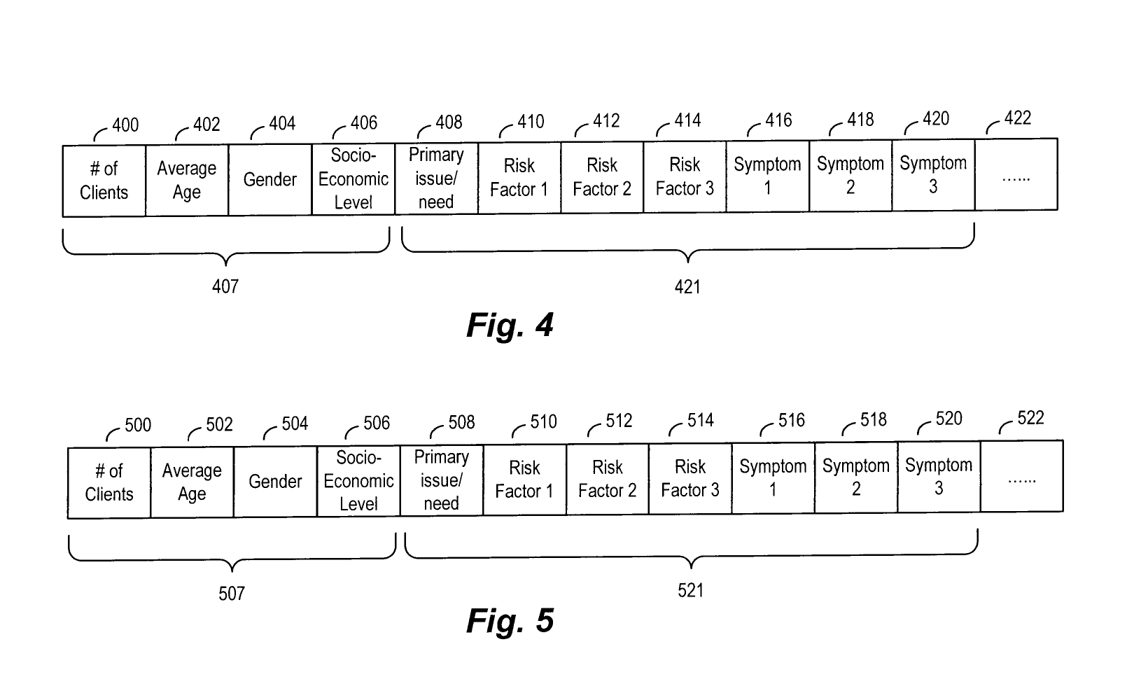

FIG. 4 is a data structure of the client attribute data that is used to characterize a particular client according to certain embodiments. Each of the different components, which will soon be discussed, is used to characterize the constituent components. The client attributes may vary depending on the query of step S302 that is based on the primary issue and/or need of the client, such as whether an elderly client is struggling with losing his or her independence or whether a child is having difficulty with making friends at school. Moreover, the constituent components of the client attribute vector are shown in FIG. 4, and one example of the components of the stored client needs profiles in the database 6 are shown in FIG. 5.

With regard to FIG. 4, each of the components will now be discussed with respect to typical attributes that can be part of the client attribute vector. Attribute 400, A1, relates to a number of people the social worker is working with for a particular case. The values for attribute A1 range between 0 and 1, and an example breakdown of how the values are mapped into the number of publications in the subject area is shown in TABLE 1. While the values are shown to range between 0 and 1, this has been done as a matter of convenience to normalize the impact of each attribute. Other ranges of values may be used as well, perhaps even without each attribute having a same range so that some attributes may be weighted more heavily than others.

TABLE 1

| CLIENT | | |
|---|---|---|
| ATTRIBUTE, | | VALUE |
| A1, 400 | # of clients | Range 0 to 1 |
| A1, 400 | =1 (Individual) | .2 |
| | 2 (Couple) | .4 |
| | 3 to 10 (Family) | .6 |
| | 10 to 250 (Group) | .8 |
| | >251 (Community) | 1 |

Attribute 402, A2, includes an average age of the client. Example values for A2 are shown in TABLE 2 below.

TABLE 2

| RESEARCH | | |
|---|---|---|
| ATTRIBUTE, | | VALUE |
| A2, 402 | Average age | Range 0 to 1 |
| A2, 402 | <12 | 0 |
| | 13-20 | .25 |
| | 21-45 | .50 |
| | 45-75 | .75 |
| | >75 | 1 |

Attribute 404, A3, includes gender of the client. Example values for A3 are shown in TABLE 3 below.

TABLE 3

| RESEARCH | | |
|---|---|---|
| ATTRIBUTE, | | VALUE |
| A3, 404 | Gender | Range 0 to 1 |
| A3, 404 | Male | 0 |
| | Female | 0.5 |
| | Other | 1 |

Attribute 406, A4, includes a socioeconomic level of a client, which can be classified by an average household income. Example values for A4 are shown in TABLE 4 below.

TABLE 4

| RESEARCH | | |
|---|---|---|
| ATTRIBUTE, | Average | VALUE |
| A4, 406 | household income | Range 0 to 1 |
| A4, 406 | <$25,000 | 0 |
| | $25,000-$49,999 | .25 |
| | $50,000-$74,999 | .50 |
| | $75,000-$99,999 | .75 |
| | >$100,000 | 1 |

Attributes 400-406 are basic informational components regarding the client that can be independent of the issue the client is experiencing. These components of the client attribute vector are referred to as basic profile components 407. For example, the age, gender, and socioeconomic level of the client give a snapshot view of who the client is but may not describe the nature of the client's problem. However, the basic profile components 407 may provide insight into root cause of the client's primary issue and other symptoms described by the remaining components in the client attribute vector.

Attribute 408, A5, includes the primary issue and/or need of the client, which can vary depending on the type of client and situation. According to one aspect, the primary issue and/or need that the client has is a type of marital unhappiness. Example values for A5 are shown in TABLE 5 below.

TABLE 5

| RESEARCH | | |
|---|---|---|
| ATTRIBUTE, | | VALUE |
| A5, 408 | Primary issue and/or need | Range 0 to 1 |
| A5, 408 | Disputes over finances | 0 |
| | Disputes over in-laws | .25 |
| | Disputes over childrearing | .50 |
| | General unhappiness | .75 |
| | Physical abuse | 1 |

Attributes 410 (A6), 412 (A7), and 414 (A8) include risk factors associated with the primary issue and/or need of the client, which can vary depending on the type of client and situation. According to one aspect, the primary issue and/or need that the client has is a type of marital unhappiness. One risk factor associated with marital unhappiness may be the number of years of marriage. Example values for A6 are shown in TABLE 6 below. Values for A7 and A8 may be associated with other risk factors pertaining to marital unhappiness, which may be number of instances of infidelity, number of common goals and beliefs, and the like.

TABLE 6

| RESEARCH | | |
|---|---|---|
| ATTRIBUTE, | | VALUE |
| A6, 410 | # of years of marriage | Range 0 to 1 |
| A6, 410 | <2 | 0 |
| | 2-5 | .35 |
| | 6-10 | .55 |
| | 10-20 | .75 |
| | >20 | 1 |

Attributes 416 (A9), 418 (A10), and 420 (A11) include additional symptoms associated with the primary issue and/or need of the client, which can vary depending on the type of client and situation. According to one aspect, the primary issue and/or need that the client has is a type of marital unhappiness. One additional symptom associated with marital unhappiness may be a low amount of time spent as a couple per week. Example values for A9 are shown in TABLE 7 below. Values for A10 and A11 may be associated with other symptoms pertaining to marital unhappiness, which may be amount of alcohol consumption per week, shortness of tempers, and the like.

TABLE 7

| RESEARCH | | |
|---|---|---|
| ATTRIBUTE, | # of hours spent as a couple | VALUE |
| A9, 416 | per week | Range 0 to 1 |
| A9, 416 | <1 | 0 |
| | 1-5 | .25 |
| | 6-10 | .50 |
| | 10-20 | .75 |
| | >20 | 1 |

Attributes 408-420 are components pertaining to the primary issue and/or need that the client is experiencing. These components of the client attribute vector are referred to as social issue components 421. For example, the symptoms and risk factors of the client can be key indicators of the root cause of the problem.

Attribute(s) 422 are expansion attributes that may compliment the other attributes included in FIG. 4. Examples of these expansion attributes include additional risk factors, additional symptoms, as well as other attributes. The expansion attributes can be categorized under the basic profile components 407 or the social issue components 421. These too would have exemplary value ranges between 0 and 1.

FIG. 5 is a data structure of a client needs profile vector that includes attributes regarding potential client needs profiles that are stored in the database 6 according to certain embodiments. According to some aspects, the components of the client needs profile vector may be of the same type and number as the components of the client attribute vector of FIG. 4.

Attribute 500, P1, relates to a number of clients normally associated with the client profile. Example values for P1 are shown in TABLE 8 below.

TABLE 8

| CLIENT | | |
|---|---|---|
| ATTRIBUTE, | | VALUE |
| P1, 500 | # of clients | Range 0 to 1 |
| P1, 500 | =1 (Individual) | .2 |
| | 2 (Couple) | .4 |
| | 3 to 10 (Family) | .6 |
| | 10 to 250 (Group) | .8 |
| | >251 (Community) | 1 |

Attribute 502, P2, includes an average age of the client for the client needs profile. Example values for P2 are shown in TABLE 9 below.

TABLE 9

| RESEARCH | | |
|---|---|---|
| ATTRIBUTE, | | VALUE |
| P2, 502 | Average age | Range 0 to 1 |
| P2, 502 | <12 | 0 |
| | 13-20 | .25 |
| | 21-45 | .50 |
| | 45-75 | .75 |
| | >75 | 1 |

Attribute 504, P3, includes gender of the client. Example values for P3 are shown in TABLE 10 below.

TABLE 10

| RESEARCH | | |
|---|---|---|
| ATTRIBUTE, | | VALUE |
| P3, 504 | Gender | Range 0 to 1 |
| P3, 504 | Male | 0 |
| | Female | 0.5 |
| | Other | 1 |

Attribute 506, P4, includes a socioeconomic level of a client, which can be classified by an average household income. Example values for P4 are shown in TABLE 11 below.

TABLE 11

| RESEARCH | | |
|---|---|---|
| ATTRIBUTE, | | VALUE |
| P4, 506 | Average household income | Range 0 to 1 |
| P4, 506 | <$25,000 | 0 |
| | $25,000-$49,999 | .25 |
| | $50,000-$74,999 | .50 |
| | $75,000-$99,999 | .75 |
| | >$100,000 | 1 |

Attributes 500-506 are basic informational components regarding a potential client that can be independent of the issue described by the client needs profile vector. These components of the client needs profile vector are referred to as basic profile components 507. For example, the age, gender, and socioeconomic level of the potential client may give a snapshot view of a typical client who may experience a particular issue but may not describe the nature of the client's problem. However, the basic profile components 507 may provide insight into root cause of the primary issue and/or need described by the remaining components in the client profile vector.

Attribute 508, P5, includes the primary issue and/or need of the client, which can vary depending on the type of client and situation. According to one aspect, the primary issue and/or need for an elderly client is a loss of independence. Example values for P5 are shown in TABLE 12 below.

TABLE 12

| RESEARCH | | |
|---|---|---|
| ATTRIBUTE, | | VALUE |
| P5, 508 | Primary issue and/or need | Range 0 to 1 |
| P5, 508 | Loses common items such | 0 |
| | as keys | |
| | Cannot remember daily | .25 |
| | tasks | |
| | Difficulty driving | .50 |
| | Inability to prepare meals. | 75 |
| | Physical ailments that | 1 |
| | prevent accomplishing | |
| | common tasks | |

Attributes 510 (P6), 512 (P7), and 514 (P8) include risk factors associated with the primary issue and/or need of the client, which can vary depending on the type of client and situation. According to one aspect, the primary issue and/or need that the elderly client has is a loss of independence. One risk factor associated a loss of independence may be the living arrangements of the client. Example values for P6 are shown in TABLE 13 below. Values for P7 and P8 may be associated with other risk factors pertaining to the loss of independence of an elderly client, which may be a medical diagnosis of dementia or other memory disorders, recent death of a spouse, and the like.

TABLE 13

| RESEARCH | | |
|---|---|---|
| ATTRIBUTE, | | VALUE |
| P6, 510 | Living arrangements | Range 0 to 1 |
| P6, 510 | Lives alone | 0 |
| | Lives with one other person | .25 |
| | >80 years of age | |
| | Lives with a caretaker such | .50 |
| | as a child | |
| | Lives in an unassisted | .75 |
| | retirement community | |
| | Lives in an assisted living | 1 |
| | home | |

Attributes 516 (P9), 518 (P10), and 520 (P11) include additional symptoms associated with the primary issue and/or need of the client, which can vary depending on the type of client and situation. According to one aspect, the primary issue and/or need that elderly client has is a loss of independence. One additional symptom associated with a loss of independence may be a diagnosis of a significant ailment or disease that affects the client's physical mobility. Example values for P9 are shown in TABLE 14 below. Values for P10 and P11 may be associated with other symptoms pertaining to marital unhappiness, which may be a diagnosis of depression, traffic tickets due to negligence, and the like.

TABLE 14

| RESEARCH | | |
|---|---|---|
| ATTRIBUTE, | | VALUE |
| P9, 516 | Mobility affecting disease | Range 0 to 1 |
| P9, 516 | Osteoporosis | 0 |
| | Arthritis | .25 |
| | Herniated disk in spine | .50 |
| | Joint replacement | .75 |
| | Cancer | 1 |

Attributes 508-520 are components pertaining to the social issue that the client is experiencing for the particular client needs profile vector. These components of the client needs profile vector are referred to as social issue components 521. For example, the symptoms and risk factors of the client can be key indicators of the root cause of the problem.

Attribute(s) 522 are expansion attributes that may compliment the other attributes included in FIG. 5. Examples of these expansion attributes include additional risk factors, additional symptoms, as well as other attributes. The expansion attributes can be categorized under the basic profile components 507 or the social issue components 521. These too would have exemplary value ranges between 0 and 1.

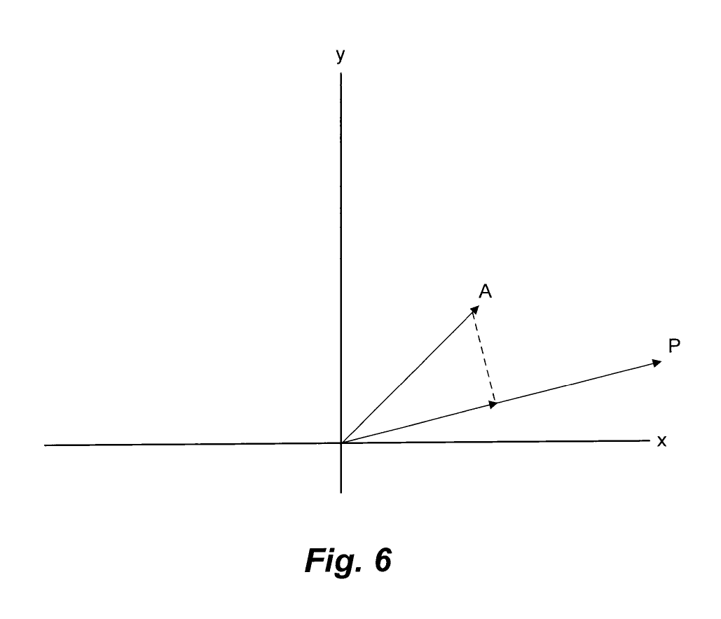

Next, FIG. 6 is a graph of a client attribute vector and a client needs profile vector in two dimensional space according to certain embodiments. As seen, the client attribute vector, A, may reflect some but not all of the attributes covered by one particular client needs profile vector, P. If this is the case, the magnitude of the projection vector of the client attribute vector, A, onto the client profile vector, P, may indicate an amount of commonality between the two vectors. Accordingly, a comparison of projection vectors of the client attribute vector, A, onto the entire set or a subset of the client needs profile vectors stored in database 6 may indicate one or more root causes of the client's problem.

Although there are different axes x and y shown, these axes are not necessarily orthogonal, but instead have some attributes in one of the vectors (A or P) that are correlated with other attributes in other vectors. Nevertheless, in order to identify how a set of client attribute data maps into the two domains, a mapping process is performed to see how the client attribute vector maps onto one or more client profile vectors. The magnitude of the vectors along each axis is a function of the additive values of the attributes that make up the vector. For example, in the client attribute vector, the range of values of average household income may be $0 to >$100,000, for example. The maximum contribution to the magnitude of the A vector is if the client has the same average household income as the average household income in the client profile vector. This particular attribute (average household income) can then be weighted based on a weighting table (as will be discussed) to help normalize the amount of contribution that attribute may have relative to other attributes that make up the vector.

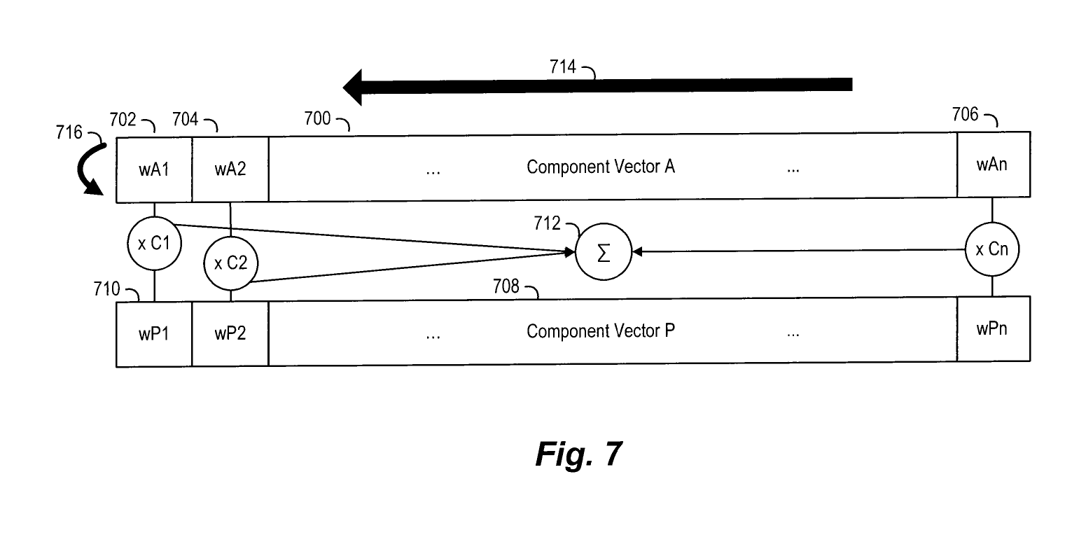

FIG. 7 is a graphical illustration of how pairs of vectors (P, A) are compared to one another to arrive at a determination of an amount of commonality between the two vectors according to certain embodiments. FIG. 7 includes vector A 700 with exemplary weighted attributes w1aA1 702, w2aA2, and wnaAn (the weights are shown for brevity in the Figure as w), although other weighted attributes would be included in the process. The respective weights are set based on the query that is made based on the primary issue and/or need of the client (e.g., a couple experiencing marital unhappiness, an elderly person losing independence) to account for the relative influence that attribute should have in the comparing and vector correlation process. Vector P 708 includes similar weighted attributes, such as w1pP1. Weighting the attributes adjusts the spatial size associated with that particular attribute, thus affecting the potential size of the correspondence graph for that particular vector (e.g., it affects how big the A shape is on the correspondence vector, for example). Weighting the correlation calculations adjusts the relative contributions each pair of components (e.g., A1, P1) contributes to an overlap area in the correspondence graph (e.g., the projection of the A vector onto the P vector).

In a first multiplication step, w1aA1 702 is multiplied with w1pP1 710, and the product is multiplied by a correlation weight C1 and the result sent to an accumulator (summation device) 712. The correlation weight C1 is a coefficient that adjusts the level of relevance for the matching pair for the query made. The products from the other matching pairs of weighted components from the vectors are multiplied (e.g., w2aA2×w2pP2 . . . wnaAn×wnpPn), adjusted by their respective correlation weight (Cx, x being an index), and summed in the accumulator 712. Then the weighted attributes in one vector (vector A 700 in this example) are shifted left 714 by one position and then then are multiplied by the corresponding weighted attribute in vector P 708 and correlation weight C2. For example, in the second step w2aA2 704 is multiplied by w1pP1 710 and the product is multiplied by a correlation weight Cx and the result is summed with the other products in the accumulator 712. The one exception is that the left most weighted attribute (which in this case is w1aA1) is circular shifted right 716 so as to take the position of wnaAn 706. This process continues until all of the weighted attributes of one vector are multiplied, adjusted by a correlation weight, and summed with all the other attributes of the other vector.

With regard to the weights, each attribute of each vector is first weighted such that each attribute is either weighted with a 0 or a value between zero and 1. A zero value means that the subject attribute does not contribute at all. Values closer to 1 are deemed to be associated with attributes that have a higher relevance toward the primary issue and/or need of the client. Each attribute of each vector is then combined (multiplied in this example, but could also be added or combined in another mathematical fashion) with each attribute of the other vectors, and a resultant sum is obtained. The weighted vector correlation of the A and P vectors results in the overlap area of the two vectors.

While in the above-described embodiment, there a fixed weight is assigned to each attribute for each vector. However, for an even more refined correlation process, a separate weight is applied for each attribute for each multiplication performed. For example, there may be a high correlation between a client who suffers from alcoholism and a familial history of alcoholism. However, there may be little correlation weight for loss of independence for an elderly client and the client's gender.

Each query will have a relevant subset of weights for each vector (signifying the contribution of each particular attribute to each vector space in the correspondence graph (e.g., the size of region A). Furthermore the correlation between the two spaces (e.g., between A and P) is influenced by the weight of the correspondence of each pair of vector attributes (e.g., A1, P1) for that particular query. The tables below include the attribute weights and correlation weights for each inquiry. For any weight or coefficient not particularly provided for, its value is set at 0.5, although it may be changed to any value ranging between 0 and 1.

Attribute Weight table for the primary issue and/or need: A child having a sudden decrease in academic performance.

TABLE 15

| Attribute | 1 | 2 | 3 | 4 | 5 | 6 | 7 | 8 | 9 | 10 | 11 | 12 |
|---|---|---|---|---|---|---|---|---|---|---|---|---|
| A | .8 | 1 | .6 | .7 | .7 | .8 | .6 | .8 | .8 | .9 | .7 | 1 |
| P | .8 | .9 | .8 | .9 | 1 | .9 | .8 | .7 | .6 | .5 | .4 | |

A vector Correlation Coefficient Table for P regarding the primary issue and/or need: A child having a sudden decrease in academic performance.

TABLE 16

| Attribute | CCp1 | CCp2 | CCp3 | CCp4 | CCp5 | CCp6 | CCp7 | CCp8 | CCp9 | CCp10 | CCp11 |
|---|---|---|---|---|---|---|---|---|---|---|---|
| A1 | 1 | .8 | .8 | .8 | 1 | .8 | .6 | .4 | .2 | .1 | .1 |
| A2 | 1 | .8 | .8 | .8 | 1 | .8 | .6 | .4 | .2 | .1 | .1 |
| A3 | 1 | .8 | .8 | .8 | 1 | .8 | .6 | .4 | .2 | .1 | .1 |
| A4 | .8 | .8 | .6 | .8 | .8 | .6 | .4 | .2 | .1 | .1 | .1 |
| A5 | .8 | .8 | .6 | .8 | .8 | .6 | .4 | .2 | .1 | .1 | .1 |
| A6 | 1 | 1 | 1 | 1 | 1 | 1 | 1 | 1 | 1 | 1 | 1 |
| A7 | .8 | .8 | .6 | .8 | .8 | .6 | .4 | .2 | .1 | .1 | .1 |
| A8 | .9 | .9 | .7 | .8 | .9 | .7 | .5 | .3 | .1 | 0 | .5 |
| A9 | .9 | .9 | .7 | .8 | .9 | .7 | .5 | .3 | .1 | 0 | .5 |
| A10 | .9 | .9 | .7 | .8 | .9 | .7 | .5 | .3 | .1 | 0 | .5 |
| A11 | .9 | .9 | .7 | .8 | .9 | .7 | .5 | .3 | .1 | 0 | .5 |
| A12 | .9 | .9 | .7 | .8 | .9 | .7 | .5 | .3 | .1 | 0 | .5 |

This process of identifying attributes, weights and correlation coefficients may be applied to other A-P correspondence space analyses for different client needs profile vectors as well as other database queries. Similar weight and coefficient tables are stored for queries relating to individuals, families, groups, and communities such as problems with gang violence in a particular community, a problem with bullying among students at a school, a family dealing with the death of an immediate family member, or a child in need of an adoptive family.

Next, FIG. 8 is a flowchart of a vector overlap process 800 for determining the overlap amounts for the client attribute vector and the different component client profile vectors according to certain embodiments. The process begins in step S802 where each of the vector attributes has a weight applied thereto. The weights are stored in a memory table and are predetermined for the particular primary issue and/or need. The process then proceeds to step S804 where pairs of weighted adjacent attributes are multiplied with each other, and then in S806 the products of all the multiplications are accumulated. Then in step S808 a query is made regarding whether all the pairs of attributes have been multiplied. If the response to the query is negative, the process proceeds to step S810 where the attributes in one vector are circular shifted and the process then returns to step S804. However, if the response to the query in Step S808 is affirmative, the process proceeds to S812, where the cumulative output is produced and used for graphical analysis. The value that is output is fraction of the total overlap if the max weight is applied to the max value of all attributes for all vectors and the correlation is performed on that maximum condition. Moreover, the output that is produced at step S812 can be a percentage of the maximum possible overlap space for the client attribute vector and the different component client needs profile vectors.

The output produced at step S812 is then sent to step S306 of the client attribute comparison process. The output at step S306 can be at least one root cause of the problem the client is experiencing based on the percentage of the maximum possible overlap space between the client attribute vector and the database of client profile vectors. The user, such as a social worker, can indicate at the interface of the computer 2 a number of potential root causes with the highest percentage of overlap be output at step S306 so that the social worker can select the root cause that is most likely the reason why the client is experiencing the symptoms that were input into the client attribute vector. According to certain embodiments, the output at step S306 can also be referred to as the client diagnosis.

Next, FIG. 9 is an exemplary flowchart of a client treatment and goal setting process S204 according to certain embodiments. At step S900, processing circuitry receives the client needs profile vector from the client attribute comparison process of step S202 that most closely describes the at least one root cause of the social issue that the client is dealing with. At step S902, the selected client needs profile vector is used to conduct a query of the database 6 to identify at least one potential observable, measurable goal and/or at least one treatment for the client that will address the root cause of the primary issue and/or need of the client. The goals and treatments that are stored in the database 6 are tied to one or more client needs profile vectors so that the client needs profile vector that is used in the database query of step S902 generates a predetermined set of goals and/or treatments for the primary issue and/or need that the client attribute comparison process of step S202 identified. For example, for the elderly client who suffers from losing independence, the goals and/or treatments stored in the database 6 that may be associated with the client needs profile vector can include taking medications on time each day for a month, calling a family member each day at the same time to check in, preparing at least one meal each day, and the like.

At step S904, the goals and/or treatments that are identified for the client through the database 6 query of step S902 are customized to the client based on the basic profile information of the client. For some client profile vectors, there may be different sets of goals and/or treatments in the database 6 depending on the basic profile components 407 of the client attribute vector. For example, in the case of a foster child who is placed in an adoptive home, the age of the child can affect the goals and/or treatments that are used to aid the child in adapting to his or her new environment as well as measure the success the child has with respect to the goals and/or treatments. In the database 6, there may be different sets of goals and/or treatments tied to the client needs profile vector based children's age ranges. For example, an infant who has been placed in an adoptive home may have goals and/or treatments identified such as bonding to new parents, sleeping through the night, taking a bottle, and the like. In another example where the child is 10 years old, some goals that may be identified include increase in school performance, ease of developing friendships, number of hobbies, number of outbursts, and the like. At step S906, the goals and/or treatments that were identified through the database query of step S902 and the customization of goals and/or treatments to the client at step S904 are output to the user, such as the social worker, via an interface at a computer 2. The user can then review the goals and/or treatments generated by the social work plan development apparatus and determine the course of action for treatment of the client to achieve the goals.

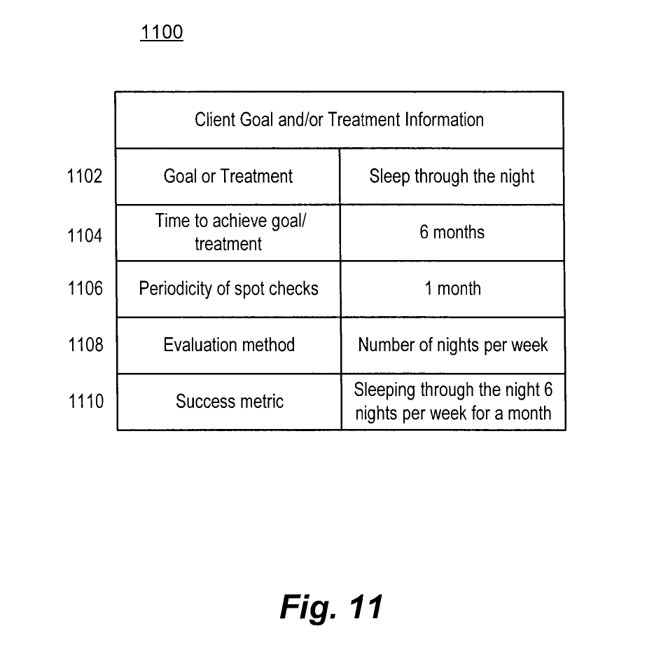

Next, FIG. 10 is an exemplary flowchart of a client evaluation process S206 according to certain embodiments. At step S1000, the processing circuitry receives the at least one goal and/or treatment output at step S904 of the client goal setting process of step S204. Each goal and/or treatment that is identified can also have additional information tied to it. FIG. 11 illustrates a non-limiting example of client goal and/or treatment information 1100 for an infant foster child who is adopted according to certain embodiments. At 1102, the goal that was identified is sleeping through the night. At 1104, a recommended time to reach the goal is 6 months. At 1106, a recommended periodicity with which the social worker should spot check the goal is 1 month. At 1108, the method of evaluation to measure whether the goal has been achieved is determining the number of nights per week that the child sleeps through the night. At 1110, a metric by which successful accomplishment of a goal will be measured is identified. In this example, the goal is determined to be successfully achieved if the infant sleeps through the night for 6 nights per week for a month.

Referring back to FIG. 10, at step S1002, evaluation timeframes are generated for the identified goals and/or treatments based on the information received at step S1000. For example, for the infant foster child, there may be a suggested timeframe of 6 months to sleep through the night after being adopted with a periodic spot check on the status of the goal each month. This timeframe along with the other timeframes associated with the other identified goals and/or treatments can be displayed concurrently with one another on a calendar via an interface on the computer 2. Reminders can also be generated at the social work plan development apparatus to alert the social worker that at least one periodic spot checks and/or evaluation may be due.

At step S1004, the success of the client at achieving a particular goal or completing a particular treatment is evaluated based on the goal information received at step S1000. According to some embodiments, the client success evaluation can be completed during the periodic spot checks or during the evaluation at the end of the recommended timeframe. For the example goal of the child sleeping through the night after 6 months, if the child meets the success metric of 1110, the goal is determined to be successfully met. However, if the goal has not yet been successfully met, a percentage of accomplishment is determined. For example, if the child is only sleeping through the night 3 times per week, the goal would be considered to be about 50% accomplished. At step S1006 a decision point determines if the client has made adequate progress with respect to the goal and/or treatment. In some aspects, for the periodic spot checks, the social worker may specify a percentage threshold of improvement that should be seen to deem the client's progress adequate. For the evaluation at the end of the recommended timeframe, the social worker can also specify another percentage of goal accomplishment that is considered acceptable. If the client has made adequate progress with respect to the goal and/or treatment, resulting in a “yes” at step S1006, the process returns to step S1004 to conduct another evaluation of the client's progress at the indicated periodicity.

Otherwise, if the client has not made adequate progress with respect to the goal and/or treatment, resulting in a “no” at step S1006, step S1008 is executed. Step S1008 is a decision point where it is determined if a new issue with the client has been identified. This decision is executed through the interface with the computer 2 where the social worker is able to input reasons why the goal was not accomplished. If the social worker indicates that another issue with the client has been identified, resulting in a “yes” at step S1008, the process returns to step S202 to begin another iteration of the social work plan development process 200 for the newly identified issue. Otherwise, if the social worker does not identify a new issue, resulting in a “no” at step S1008, the social worker has the opportunity to manually adjust the overall timeframe of the goal and/or treatment at the interface at the computer 2 so that it suits the client's needs. For example, if the infant foster child is not able to sleep through the night after 6 months with the adoptive family but is showing progress with respect to other goals and/or treatments, and the social worker does not identify any additional issues, the social worker may add a number of extra months onto the timeframe for goal and/or treatment accomplishment.

The methods and processes for the embodiments described above may be embodied in, and fully automated via, software code modules executed by one or more general-purpose computers, a server, an appliance, etc. The code modules for implementing the models described above may be stored in any type of computer-readable medium or other computer storage device and executed by one or more processors. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like.

The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases, relational databases and flat file systems that use magnetic disk storage and/or solid state RAM. Some or all of the components shown in may also be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner.

Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and sub combinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

Furthermore, the terms “approximately,” “about,” and similar terms generally refer to ranges that include the identified value within a margin of 20%, 10%, or preferably 5%, and any values therebetween.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure.

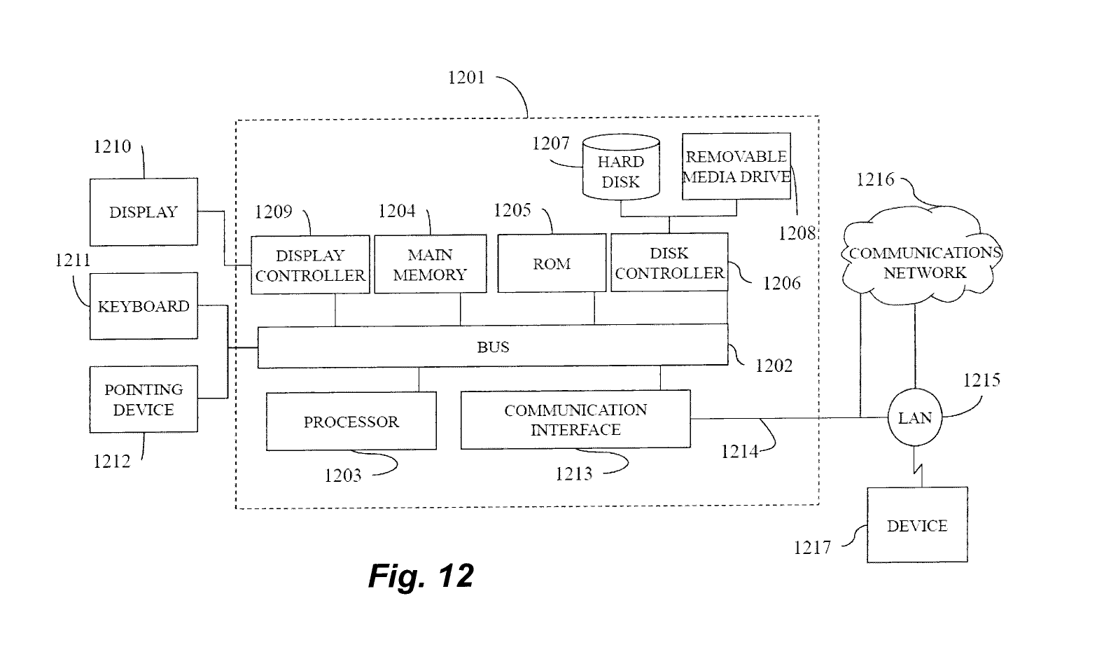

Each of the functions described in the embodiments may be implemented by one or more processing circuits (or circuitry). A processing circuit includes a programmed processor (for example, processor 1203 of FIG. 12), as a processor includes circuitry. A processing circuit also includes devices such as an application specific integrated circuit (ASIC) and conventional circuit components arranged to perform the recited functions.

FIG. 12 illustrates a computer system 1201 upon which embodiments of the present disclosure may be implemented.

The computer system 1201 includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as the touch panel display 101 or a liquid crystal display (LCD), for displaying information to a computer user. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1201, for driving a device or devices for implementing the invention, and for enabling the computer system 1201 to interact with a human user. Such software may include, but is not limited to, device drivers, operating systems, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media, on the contrary, includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an integrated services digital network (ISDN) card. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A social work plan development apparatus, comprising:
processing circuitry configured to
store a plurality of client needs profiles as a plurality of vectors P in at least one database held in a storage device,
receive a query that includes client attribute data based on one or more primary issues and/or needs of a client,
characterize the client attribute data as an A vector for the query,
correlate the A vector with the plurality of P vectors to determine magnitude of correlation between the A vector and the plurality of P vectors with respect to the query through a vector overlap process,
determine at least one root cause for the one or more issues and/or needs of the client based on the magnitude of correlation between the A vector and the plurality of P vectors,
determine at least one goal and/or treatment for the client that addresses the at least one root cause for the one or more issues and/or needs of the client, and
evaluate client progress based on a percentage of accomplishment of the at least one goal and/or treatment within a predetermined time.

2. The social work plan development apparatus of claim 1, wherein the A vector and the plurality of P vectors contain one or more basic profile components and one or more social issue components.

3. The social work plan development apparatus of claim 2, wherein the vector overlap process is further configured to apply weights to the A vector and the plurality of P vectors based on the query that is made.

4. The social work plan development apparatus of claim 3, wherein the vector overlap process is further configured to determine a percentage of correlation between the A vector and the plurality of P vectors.

5. The social work plan development apparatus of claim 4, wherein the output of the vector overlap process is at least one of the plurality client needs profiles that describes the at least one root cause of the one or more issues and/or needs of the client.

6. The social work plan development apparatus of claim 1, wherein the at least one database is configured to store client goal and/or treatment information pertaining to the plurality of client needs profiles.

7. The social work plan development apparatus of claim 6, wherein the client goal and/or treatment information includes a time to accomplish the at least one goal and/or treatment, a periodicity to spot check progress toward accomplishing the at least one goal and/or treatment, an evaluation method for determining the progress the client has made toward accomplishing the at least one goal and/or treatment, and a metric for determining successful accomplishment of the at least one goal and/or treatment.

8. The social work plan development apparatus of claim 7, wherein the client goal and/or treatment information stored in the at least one database is tied to at least one of the plurality of client needs profiles.

9. The social work plan development apparatus of claim 8, wherein the processing circuitry is further configured to customize the one or more goals and/or treatments to the client based on the at least one root cause for the one or more issues and/or needs of the client.

10. The social work plan development apparatus of claim 9, wherein the processing circuitry is further configured to alert a user when an evaluation for the at least one goal and/or treatment is due.

11. The social work plan development apparatus of claim 1, wherein the client can include one person, a couple, a family, a group, or a community.

12. A non-transitory computer-readable medium having computer-readable instructions thereon which when executed by a computer cause the computer to perform a method for developing a social work plan, the method comprising:
storing a plurality of client needs profiles as a plurality of vectors P in at least one database held in a storage device;
receiving a query that includes client attribute data based on one or more primary issues and/or needs of a client;
characterizing with circuitry the client attribute data as an A vector for the query;
correlating with the circuitry the A vector with the plurality of P vectors to determine magnitude of correlation between the A vector and the plurality of P vectors with respect to the query through a vector overlap process;
determining with the circuitry at least one root cause for the one or more issues and/or needs of the client based on the magnitude of correlation between the A vector and the plurality of P vectors;
determining with the circuitry at least one goal and/or treatment for the client that addresses the at least one root cause for the one or more issues and/or needs of the client; and
evaluating with the circuitry client progress based on a percentage of accomplishment of the at least one goal and/or treatment within a predetermined time.

13. A method for developing a social work plan, the method comprising:
storing, in at least one database held in a storage device, a plurality of client needs profiles as a plurality of vectors P;
receiving, at a client device, a query that includes client attribute data based on one or more primary issues and/or needs of a client;
characterizing, via circuitry, the client attribute data as an A vector for the query;
correlating, via the circuitry, the A vector with the plurality of P vectors to determine magnitude of correlation between the A vector and the plurality of P vectors with respect to the query through a vector overlap process;
determining, via the circuitry, at least one root cause for the one or more issues and/or needs of the client based on the magnitude of correlation between the A vector and the plurality of P vectors;
determining, via the circuitry, at least one goal and/or treatment for the client that addresses the at least one root cause for the one or more issues and/or needs of the client; and
evaluating, at the client device, client progress based on a percentage of accomplishment of the at least one goal and/or treatment within a predetermined time.

14. The method of claim 13, wherein the A vector and the plurality of P vectors contain one or more basic profile components and one or more social issue components.

15. The method of claim 14, wherein the vector overlap process is further configured to apply weights to the A vector and the plurality of P vectors based on the query that is made.

16. The method of claim 15, wherein the vector overlap process is further configured to determine a percentage of correlation between the A vector and the plurality of P vectors.

17. The method of claim 16, wherein the output of the vector overlap process is at least one of the plurality client needs profiles that describes the at least one root cause of the one or more issues and/or needs of the client.

18. The social work plan development apparatus of claim 13, wherein the at least one database is configured to store client goal and/or treatment information pertaining to the plurality of client needs profiles.

19. The social work plan development apparatus of claim 18, wherein the client goal and/or treatment information includes a time to accomplish the at least one goal and/or treatment, a periodicity to spot check progress toward accomplishing the at least one goal and/or treatment, an evaluation method for determining the progress the client has made toward accomplishing the at least one goal and/or treatment, and a metric for determining successful accomplishment of the at least one goal and/or treatment.

20. The social work plan development apparatus of claim 19, wherein the client goal and/or treatment information stored in the at least one database is tied to at least one of the plurality of client needs profiles.
